(19) United States
(12) Patent Application Publication
(10) Pub. No.: US 2012/0042844 A1
(43) Pub. Date: Feb. 23, 2012

(54) HANDHELD PRIMER BULB STRUCTURE

(76) Inventor: K. C. CHIANG, Changhua City (TW)

(21) Appl. No.: 12/860,863

(22) Filed: Aug. 21, 2010

(51) Int. Cl. F02M 37/16

(52) U.S. Cl. 123/179.11

(57) ABSTRACT

A handheld primer bulb structure includes an outer layer, an inner layer, an intermediate layer and a chamber. The outer layer is made of a thermoplastic elastic material and has the configuration of a spherical body. The inner layer is made of a fluoroplastic material (fluorocarbon polymer) and disposed on an inner face of the outer layer. The intermediate layer is disposed between the outer layer and the inner layer for affixing the inner layer and the outer layer to each other. The chamber is surrounded and defined by the outer layer and the inner layer and the intermediate layer and has two openings.

### BACKGROUND OF THE INVENTION

1. Field of the Invention

The present invention relates generally to a device for transferring engine fuel, and more particularly to a handheld primer bulb structure.

2. Description of the Related Art

A handheld primer bulb is used to transfer engine fuel to an engine of a small-size engine-powered transportation tool such as a small-size boat. The primer bulb is a spherical or ellipsoidal body. Two ends of the primer bulb are respectively connected with two hoses. A user can manually compress and release the primer bulb to transfer the fuel to the engine.

Please refer to FIGS. 1 and 2. A conventional handheld primer bulb 91 is made of synthetic rubber or a mixture of synthetic rubber and polyvinyl chloride (PVC). Referring to FIG. 2, the shell/interface 911 of the primer bulb 91 is solely made of the aforesaid material so that the highly volatile fuel tends to permeate through the shell/interface 911 of the primer bulb 91 to the atmosphere to pollute the environment.

United State Coast Guard (USCG/SAE J1527) requires that the permeability of the fuel be not greater than 15 g/m²24 hrs. In this case, the conventional primer bulb 91 fails to meet the requirement of United State Coast Guard.

### SUMMARY OF THE INVENTION

It is therefore a primary object of the present invention to provide a handheld primer bulb structure with low permeability.

It is a further object of the present invention to provide the above handheld primer bulb structure, which meets the requirement of environmental protection.

To achieve the above and other objects, the handheld primer bulb structure of the present invention includes an outer layer, an inner layer, an intermediate layer and a chamber. The outer layer is made of a thermoplastic elastic material and has the configuration of a spherical body. The inner layer is made of a fluoroplastic material (fluorocarbon polymer) and disposed on an inner face of the outer layer. The intermediate layer is disposed between the outer layer and the inner layer for affixing the inner layer and the outer layer to each other. The chamber is surrounded and defined by the outer layer and the inner layer and the intermediate layer and has two openings.

The present invention can be best understood through the following description and accompanying drawings, wherein:

### BRIEF DESCRIPTION OF THE DRAWINGS

FIG. 1 is a perspective view of a conventional handheld primer bulb;

FIG. 2 is a sectional view taken along line A-A of FIG. 1;

FIG. 3 is a perspective view of the handheld primer bulb structure of the present invention; and

FIG. 4 is a sectional view taken along line B-B of FIG. 3.

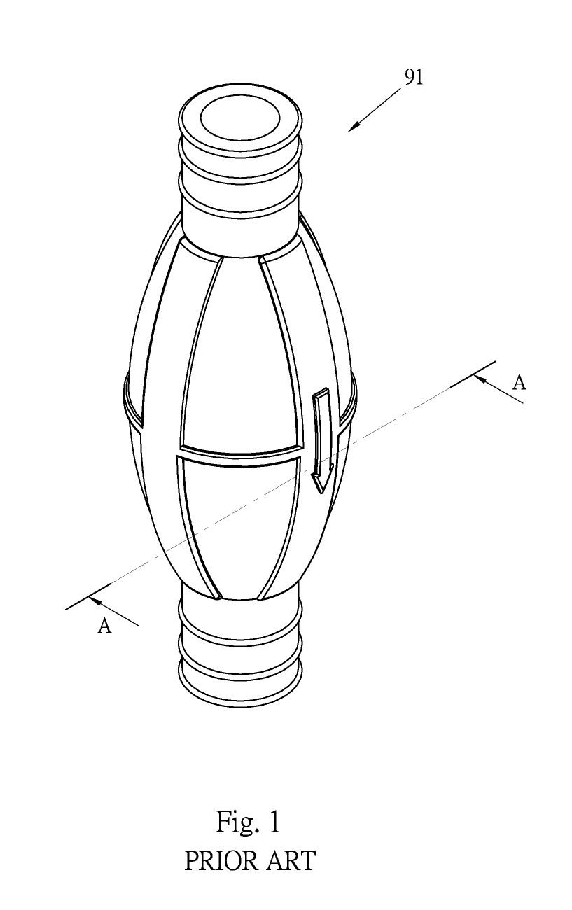

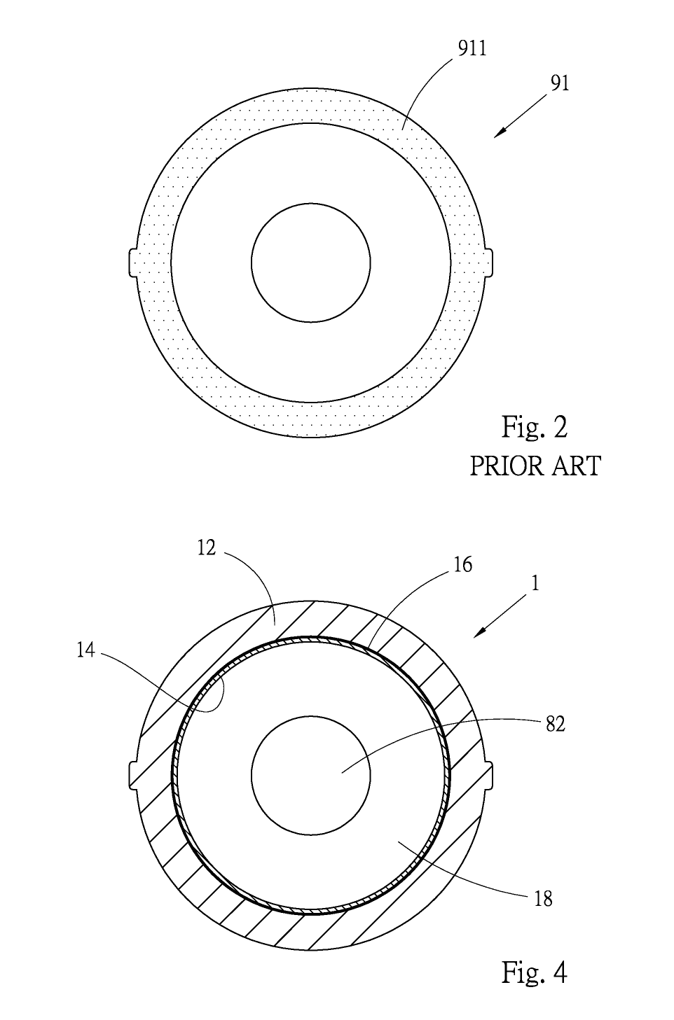

### DETAILED DESCRIPTION OF THE PREFERRED EMBODIMENTS

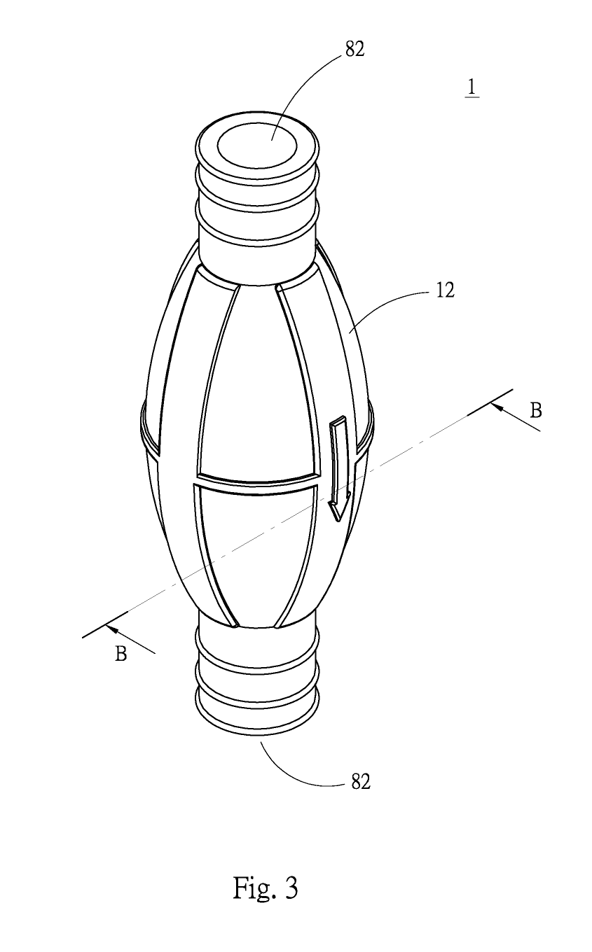

Please refer to FIGS. 3 and 4. The handheld primer bulb structure 1 of the present invention at least includes an outer layer 12, an inner layer 14, an intermediate layer 16 and a chamber 18.

The outer layer 12 is made of a thermoplastic elastic material with a mold by means of heating and molding. The thermoplastic elastic material can be rubber, polyvinyl chloride (PVC), polyurethane (PU), polyethylene (PE) or the like. The outer layer 12 can have the configuration of a spherical or ellipsoidal body.

The inner layer 14 is made of a fluoroplastic material (fluorocarbon polymer) with a mold by means of heating and molding. The inner layer 14 is disposed on an inner face of the outer layer 12 and has a configuration corresponding to that of the outer layer 12. The fluoroplastic material (fluorocarbon polymer) can be polytetrafluoroethylene (PTFE), perfluoroalkoxyethylene (PFA), fluorinatedethyleneprogylene (FEP), polychlorotrifluoroethylene (PCTFE), ethylenetetrafluoroethylene (ETFE), ethylenechlorotrifluoroethylene (ECTFE), polyvinylidene difluoride (PVDF) or the like.

The intermediate layer 16 is disposed between the outer layer 12 and the inner layer 14 for affixing the inner layer 14 and the outer layer 12 to each other. The intermediate layer 16 can be an adhesive for adhering the inner layer 14 and the outer layer 12 to each other. Alternatively, the inner layer 14 can be affixed to the outer layer 12 in the following manners:

First, the inner layer 14 can be affixed to the outer layer 12 by means of a measure similar to fusion, that is, sintering. One face of the inner layer 14 (fluorocarbon polymer), which is proximal to the outer layer 12, is heated to a high temperature. Then the inner layer 14 is compactly pressed against the inner face of the outer layer 12 and affixed thereto.

Second, in high vacuum condition under an electric field or plasma, the face of the inner layer 14 (fluorocarbon polymer), which is to be adhered to the outer layer 12, is collided with ions. Accordingly, the fluorine atoms of the face are collided away and replaced with other atoms (such as oxygen). In this case, the face of the inner layer 14 is provided with strong adhesion.

The chamber 18 is surrounded and defined by the outer layer 12, the inner layer 14, and the intermediate layer 16 and has two openings 82.

The inner layer 14 of the primer bulb structure 1 of the present invention is made of high-density fluoroplastic material (fluorocarbon polymer). When a user manually compresses the primer bulb to transfer the engine fuel, the permeability of the engine fuel is not greater than 15 g/m²24 hrs. Therefore, the primer bulb structure 1 of the present invention meets the requirement of United State Coast Guard.

The outer layer 12 of the primer bulb structure 1 of the present invention can have a thickness 15-20 times the thickness of the inner layer 14. This makes the primer bulb structure 1 of the present invention have better elasticity to achieve better effect.

The above embodiments are only used to illustrate the present invention, not intended to limit the scope thereof. Many modifications of the above embodiments can be made without departing from the spirit of the present invention.

What is claimed is:

1. A handheld primer bulb structure comprising:
an outer layer made of a thermoplastic elastic material and having the configuration being selected from the group consisting of a spherical body and a ellipsoidal body;
an inner layer made of a fluoroplastic material (fluorocarbon polymer) and disposed on an inner face of the outer layer;
an intermediate layer disposed between the outer layer and the inner layer for affixing the inner layer and the outer layer to each other; and
a chamber surrounded and defined by the outer layer, the inner layer, and the intermediate layer and having two openings.

2. The handheld primer bulb structure as claimed in claim 1, wherein the material of the outer layer is selected from the group consisting of rubber, polyvinyl chloride (PVC), polyurethane (PU) and polyethylene (PE).

3. The handheld primer bulb structure as claimed in claim 1, wherein the material of the inner layer is selected from the group consisting of polytetrafluoroethylene (PTFE), perfluoroalkoxyethylene (PFA), fluorinatedethyleneprogylene (FEP), polychlorotrifluoroethylene (PCTFE), ethylenetetrafluoroethylene (ETFE), ethylenechlorotrifluoroethylene (ECTFE) and polyvinylidene difluoride (PVDF).

4. The handheld primer bulb structure as claimed in claim 2, wherein the material of the inner layer is selected from the group consisting of polytetrafluoroethylene (PTFE), perfluoroalkoxyethylene (PFA), fluorinatedethyleneprogylene (FEP), polychlorotrifluoroethylene (PCTFE), ethylenetetrafluoroethylene (ETFE), ethylenechlorotrifluoroethylene (ECTFE) and polyvinylidene difluoride (PVDF).

5. The handheld primer bulb structure as claimed in claim 1, wherein the outer layer has a thickness 15˜20 times the thickness of the inner layer.

6. The handheld primer bulb structure as claimed in claim 2, wherein the outer layer has a thickness 15˜20 times the thickness of the inner layer.

7. The handheld primer bulb structure as claimed in claim 3, wherein the outer layer has a thickness 15˜20 times the thickness of the inner layer.

8. The handheld primer bulb structure as claimed in claim 4, wherein the outer layer has a thickness 15˜20 times the thickness of the inner layer.

9. The handheld primer bulb structure as claimed in claim 1, wherein the intermediate layer is an adhesive.

10. The handheld primer bulb structure as claimed in claim 2, wherein the intermediate layer is an adhesive.

11. The handheld primer bulb structure as claimed in claim 3, wherein the intermediate layer is an adhesive.

12. The handheld primer bulb structure as claimed in claim 4, wherein the intermediate layer is an adhesive.

13. The handheld primer bulb structure as claimed in claim 5, wherein the intermediate layer is an adhesive.

14. The handheld primer bulb structure as claimed in claim 6, wherein the intermediate layer is an adhesive.

15. The handheld primer bulb structure as claimed in claim 7, wherein the intermediate layer is an adhesive.

16. The handheld primer bulb structure as claimed in claim 8, wherein the intermediate layer is an adhesive.
